(19) United States
(12) Patent Application Publication
(10) Pub. No.: US 2004/0253500 A1
(43) Pub. Date: Dec. 16, 2004

(54) Fuel cartridge interconnect for portable fuel cells

(76) Inventors: Jordan T. Bourilkov, Stamford, CT (US); Andrew G. Gilicinski, Westborough, MA (US)

Correspondence Address: FISH & RICHARDSON PC, 225 FRANKLIN ST, BOSTON, MA, 02110, US

(21) Appl. No.: 10/462,077

(22) Filed: Jun. 13, 2003

(51) Int. Cl. H01M 8/04; H01M 2/02; H01M 2/10; H01M 16/00

(52) U.S. Cl. 429/34; 429/96; 429/164; 429/7; 429/9

(57) ABSTRACT

An electronic device includes electrical circuits that provide operative functionality of the device, a fuel cell to power the electrical circuits during certain periods of operation, an interconnect to connect between a battery and a fuel cartridge to delivery fuel to the fuel cell or power from the battery and a circuit to prevent charging of a fuel cell from a battery when a battery is attached to the interconnect.

### BACKGROUND

This invention relates to powering of portable electronic devices.

Portable electronic devices are normally powered with either a primary or a rechargeable battery. Growth in the portable electronic device market, as well as, changes in usage patterns, has provided opportunities for rechargeable sources of power to power an electronic device. While primary batteries have a greater energy density, their internal resistance is larger, and primary batteries are less suitable in high drain (>0.2 C rate of discharge) electronic devices. Rechargeable batteries can handle large loads but do not have sufficient energy capacity for many applications.

Fuel cells incorporated into power sources for portable devices promise longer runtimes than conventional battery systems, due to the ability to use high-energy content fuels. Several fuel cell technologies are currently under development for commercialization in portable power applications, namely direct methanol fuel cells (DMFC) and hydrogen PEM fuel cells (H2FC). Both require the ability to replenish fuel into the power source when it is used up.

### SUMMARY

According to an aspect of the invention, an interconnect includes an interface between a fuel cell system and a fuel cartridge or battery.

According to an aspect of the invention, an electronic device includes a operable unit that operates using a fuel cell and a housing including a compartment for receiving a fuel cartridge when the operable unit is operated by power generated by the fuel cell and for receiving a battery when the operable unit is operated by power from a battery, the housing including an interface between a fuel cell system and a fuel cartridge or battery.

According to an aspect of the invention, an article includes a generally rectangular solid shaped case for a prismatic battery having a pair of electrical terminals, housing at least one cylindrical battery having positive and negative electrodes coupled to the electrical terminals of the housing.

According to an aspect of the invention an article includes a generally rectangular solid shaped case for a prismatic battery having a pair of electrical terminals and an aperture disposed between the pair of terminals to receive an ingress port.

According to an aspect of the invention, an interconnect includes an interface between a fuel cell system and a fuel cartridge or battery and a circuit to prevent charging of a fuel cell from a battery when a battery is attached to the interconnect.

According to an aspect of the invention, an electronic device includes electrical circuits that provide operative functionality of the device, a fuel cell to power the electrical circuits during certain periods of operation, an interconnect to connect between a battery and a fuel cartridge to delivery fuel to the fuel cell or power from the battery, and a circuit to prevent charging of a fuel cell from a battery when a battery is attached to the interconnect.

In a Direct Methanol Fuel Cell (DMFC), the fuel cartridge contains a methanol solution, whereas in an hydrogen fuel cell (H₂FC) the fuel cartridge contains either stored hydrogen or a chemical system capable of producing hydrogen as needed to fuel the fuel cell and thus power the device. Such fuel cartridges could be used as external refueling tanks, from which one would pump fuel into an interior fuel tank residing inside the device. Alternately, the cartridge could be inserted into the device and reside there, providing fuel to the fuel cell until it is used up, at which time it is replaced by a new, full cartridge. The approach believed to be more likely to be preferred by consumers is the insertable cartridge approach. This is due to its inherent simplicity and convenience, which allows for “instant recharge” and minimizes a consumer's time and effort to manage the recharging process for the power source.

If fuel cells of a given type become successful as a power source for mass-market applications, it is expected that cartridges with needed fuel formulations would become widely available. Consumers using fuel cell-powered devices would purchase fuel cartridges as easily as they can purchase standard size batteries. However, during initial commercialization of fuel cells it may be difficult to find fuel cartridges at retail. Alternately, initial fuel distribution may be limited to direct sales to consumers, sale through specialty stores only, or another approach. These initial distribution models could lead to a risk that a consumer may need to purchase a cartridge but be unable to do so quickly and conveniently. A backup method of operating a device with a fuel cell power source that would allow consumers the full use of their device in such an emergency situation is therefore desirable.

Another consideration is airline transport of fuel cartridges and transportation regulations governing them. Alternate method of operating a device using a fuel cell power source that would allow consumers the use of their device while traveling, in the case of unexpected limitations on their ability to transport fuel cartridges, is therefore desirable.

Aspects of the invention provide convenient techniques for operating a fuel cell-powered device in situations where a fuel cartridge is temporarily unavailable. Devices that are powered by fuel cells would include an interconnect between the fuel cell power source and a fuel cartridge, which will allow the power source to automatically detect the insertion of a primary or charged secondary battery or batteries into the fuel cartridge cavity. The interconnect will furthermore allow the primary or secondary battery or batteries to operate their device and allow consumer use of their device in the temporary absence of a fuel cartridge.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram.

FIGS. 2A and 2B are perspective diagrammatical views of an interconnect structure coupled to a fuel cell and device electronics.

FIGS. 3 and 4 are perspective, diagrammatical views depicting exemplary arrangement for batteries and fuel cartridges.

FIGS. 5 and 6 are schematic diagrams of electronic circuits.

### DETAILED DESCRIPTION

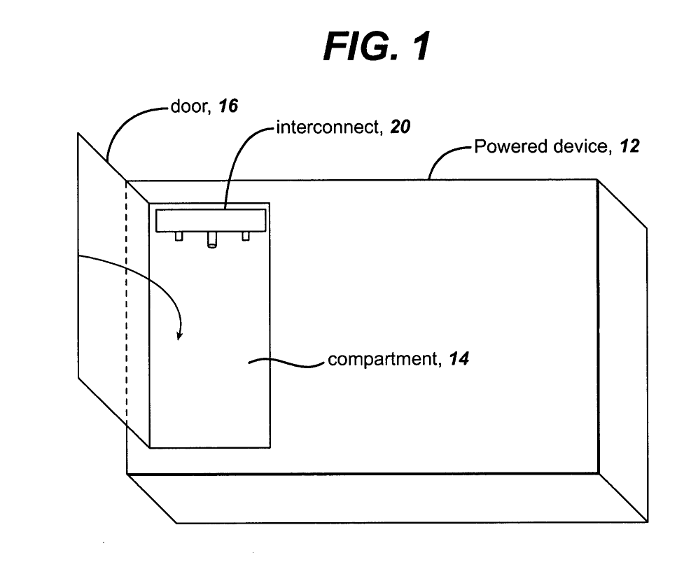

Referring to FIG. 1, a portable electronic device 12 is shown. The device 12 includes a housing 11, having a compartment 14 to house an energy source (not shown) and a door 16 to enclose the compartment. The device 12 also includes an interconnect 20 disposed in the compartment 13 (14 on FIG. 1) to interface either a battery source of power, e.g., primary or secondary, e.g., rechargeable batteries 16 or a fuel cartridge that supplies a source of fuel (a form of hydrogen) to a fuel cell (not shown). While the door is shown pivoting along a side of the compartment that is perpendicular to the interconnect 20, in some embodiments it may be desirable to access the compartment from the side opposite the interconnect 20 to permit easy insertion of batteries and fuel cartridges.

The interconnect 20 can distinguish between a fuel cartridge and a battery. The interconnect 20 provides a convenient technique to allow a fuel cell-powered device to operate in situations where a fuel cartridge is temporarily unavailable. This is accomplished by the interconnect 20 between a fuel cell power source and a fuel cartridge. The interconnect 20 allows the power source to automatically detect the insertion of a primary or charged secondary battery or batteries into the fuel cartridge cavity. The interconnect 20 allows the primary or secondary battery or batteries to operate the device and allow consumer use of their device in the temporary absence of a fuel cartridge. Device 12 can be any type of portable device such as a mobile phone, portable computer or audio/video device. In general, device 12 would include an operable portion (not shown), i.e., the part of the device that provides the device's function, a fuel cell (not shown) to provide portable power to the device and the interconnect 20 all housed within the housing 11.

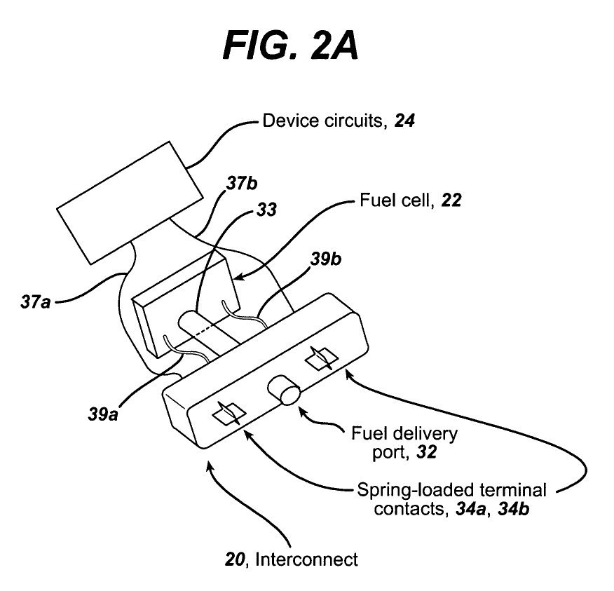

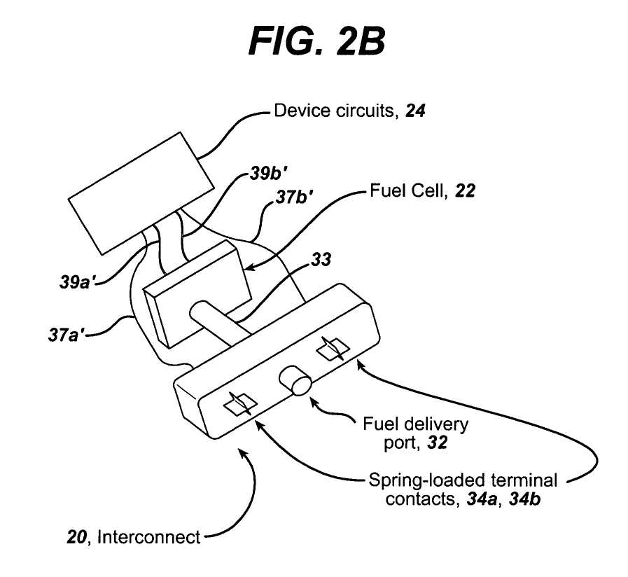

Referring to FIG. 2, interconnect 20 provides an interface between a fuel cell 22 and a fuel cartridge or battery (not shown). The interface 20 has appropriate mating fittings 32 to allow a fuel cartridge (not shown) to connect to the interface 20 and deliver fuel to the fuel cell 22 disposed in the device 12. The mating fitting 32 provides an ingress fuel interface port. The interface port 32 can be a simple valve or merely an ingress port or other configuration enabling passage of a liquid or gas fuel and allow secure, leak-proof mating with a complementary port on a fuel cartridge. The mating fitting 32 allows liquid or gas fuel to flow into the fuel cell 22, via an egress port 33 to enable operation of the fuel cell. The interface 20 also includes a pair of spring-loaded battery terminal contacts 34a, 34b disposed on a common surface of the interconnect 20 to allow for contact with battery terminals in a prismatic battery system. The fuel cell 22 receives fuel from the fuel cartridge that is connected to the interconnect 20. The fuel cell converts the fuel into electrical energy that is used to power electronic circuits 24 that provide the operational functionality for the device 12. The electronic circuits 24 can also be powered by a battery (not shown) that is connected to the interconnect 20.

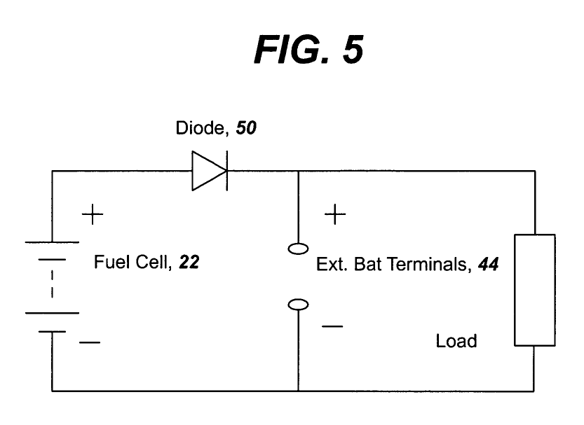

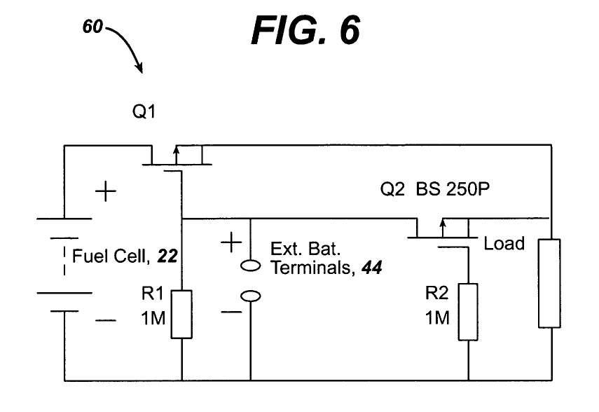

In one implementation as shown in FIG. 2A, electrical energy is delivered via electrical connections 37a, 37b that emanate from the interconnect 20. The fuel cell 22 has electrical connections 39b, 39b that couple to the interconnect 20. Circuits that switch between the battery and fuel cell supplied power to place power on the connections 37a, 37b are provided in FIGS. 5 and 6. In another implementation as shown in FIG. 2B, electrical energy from the battery is delivered via electrical connections 37a′, 37b′ that emanate from the interconnect 20 and the fuel cell 22 has electrical connections 39b′, 39b′ that couple to the device circuits 24. The circuits that switch between the battery and fuel cell supplied power described in FIGS. 5 and 6 are thus disposed on the device circuits 24.

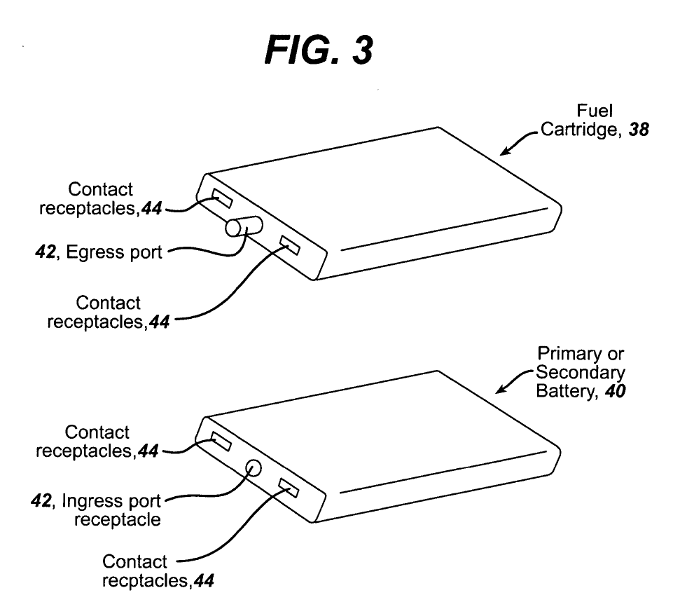

Referring to FIG. 3, a fuel cartridge 38 and a prismatic battery 40 are shown. The fuel cartridge 38 (note: not shown in FIG. 3!) has a fuel delivery interface, complementary to the interface 20 (FIG. 2), including an egress port 42, as shown. The prismatic primary or secondary battery 40 (note: not shown in FIG. 3!) has a pair of battery terminals 44 (contact receptacles) on the same side of the prismatic package, as also shown.

In addition, the battery can include a void to accept the ingress port on the interface 20 (FIG. 2) and the fuel cartridge can have a pair of battery terminals 44 (contact receptacles) on the same side of the prismatic package, as also shown. The pair of battery terminals 44 (contact receptacles) on the prismatic package are not electrically active, and in some embodiments can be short circuited to be used with an appropriate circuit to indicate that a fuel cartridge has been connected to the interconnect 20. The arrangements shown in FIG. 3 enable the interface 20 to receive either the fuel cell cartridge 38 or battery 40 so that both the fuel cartridge's fuel delivery valve mechanism, and the battery's terminals mate with their corresponding interconnect components on the interface 20 (FIG. 2).

Batteries envisioned to be compatible with the terminal contact scheme include prismatic primary lithium batteries from Duracell and other battery systems. Other battery configurations are potentially compatible with the battery terminal arrangement described above.

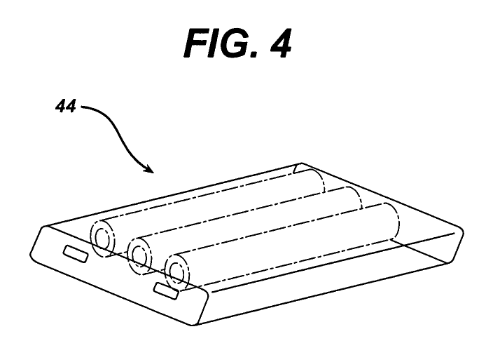

Referring to FIG. 4, a prismatic battery case 44 is shown that allows cylindrical batteries such as AA, AAA or AAAA sizes to be used as an alternative to a prismatic battery in mating with the interface 20. Such a case could be sold as an inexpensive accessory to a fuel cell-powered device, and allow consumers to purchase cylindrical batteries and insert them into the case to use as a backup cartridge. It would also connect the back terminal of a cylindrical battery to allow it to be accessed by one of the front terminals of the prismatic case. An example of one option is shown in FIG. 4, where three AAA batteries are contained within a prismatic case that allows their use with the interface 20.

An alternate configuration could be envisioned where primary or secondary cylindrical battery or batteries could be used. In the case of a single cylindrical battery, the battery terminals would need to be reconfigured to allow one to be placed on the cavity door to allow the battery to be appropriately connected to both terminals when fully inserted. In such a configuration, the fuel valve may need to serve as a battery terminal and be configured specifically to allow either simple electrical connection of the primary or secondary cylindrical battery or the connection of fuel delivery valve on the fuel cartridge. A dual configuration of cylindrical batteries could be achieved using the two battery terminals shown in FIG. 2 for one set of terminals, and a second set on the back of the cavity door which would close and provide contact for the back terminals on the cylindrical batteries.

The use of primary or secondary batteries in place of fuel for a fuel cell powered device provides a viable backup option for operation of the device. Other features of the fuel cartridge include a fuel cavity door. If the battery terminal prongs detect a battery, the detection can activate closure of a door to the fuel cartridge cavity in which the battery resides, e.g., FIG. 1. This could allow a more effective closure and improved appearance to the device in which the power source resides if the geometric design of the battery does not conform well to the fuel cartridge cavity.

A fuel delivery valve engagement mechanism (not shown) used in combination with the battery terminal prongs, upon detecting no battery present (no voltage across terminals) but detecting another signal on the location where the terminals would be located, could activate an engagement mechanism to enable a physical docking of the fuel valve system with the fuel cartridge. As an example, two small metal plates could be located on a fuel cartridge where the battery terminals would be in a prismatic battery or in the contact receptacles 44 in the fuel cartridge 38 (if used). These terminals could be short-circuited. If a circuit connected to the battery terminal prongs detects no voltage across the terminals but only a small resistance, the circuit could initiate a mechanism to mechanical dock the interface with an inserted fuel cartridge.

A simple parallel circuit on the interconnect would, upon detection of a voltage across the terminal prongs, switch from directing the output of a fuel cell to the power management circuitry to using that from the battery terminals.

Referring to FIG. 5, a silicon diode 50 is shown coupled between a fuel cell 22 and external battery terminals that can receive a battery (not shown). When the fuel cell 22 is supplying the power, the diode 50 is forward biased, and the external battery 44 terminals are at open circuit. If an external battery is connected to the contacts 44, the diode 50 is reverse biased (the fuel cell voltage without fuel supply drops to lower than the battery voltage), and the battery supplies power to the load. The diode 50 prevents charging of the fuel cell 22 from the battery that would cause energy loss and possible damage to the fuel cell 22.

Referring to FIG. 6 a transistor-based switch circuit 60 is shown. An advantage of this arrangement is that fuel/battery selection is provided with virtually no energy loss (e.g. the voltage drop across the diode in FIG. 5). When the fuel cell cartridge (not shown) is inserted and the fuel cell 22 supplies the power, the external battery terminals 44 are open circuit, and the gate of the p-channel MOSFET Q1 is biased through R1. In this case, Q1 is on and conducts from the fuel cell to the load (device electronics 24), and Q2 is off. If an external battery is inserted, the gate voltage of Q1 goes positive and turns the transistor off, preventing connection of the two power sources in parallel, and Q2 is biased through R2 and conducts the battery power to the load.

The circuits of FIGS. 5 or 6 would generally be incorporated within the interface 20 or the portable device 12, which uses portable fuel cells. The specifics will be determined by the application, the size of the device and the volume available for the power source. However, it is possible that optimum implementations could involve multiple prismatic batteries or battery cases inserted in place of a larger volume fuel cartridge, or a cylindrical battery or batteries. The specific circuitry will also be determined by the application, and by the fuel cell system's voltage output vs. that of the battery replacements.

Of course more than two battery terminals and corresponding connections to the circuits can be provided.

Further, an internal fuel gauge can be incorporated into the fuel cartridge. The fuel gauge could display remaining fuel or remaining runtime.

A number of embodiments of the invention have been described. Nevertheless, it will be understood that various modifications may be made without departing from the spirit and scope of the invention. For example, the circuit of FIG. 5 or FIG. 6 while described as being within the interconnect 20 could be located outside of the interconnect as a stand-alone circuit or as part of the electronic circuits that provide the operational functionality of the device. Accordingly, other embodiments are within the scope of the following claims.

What is claimed is:

1. An interconnect comprises:
an interface between a fuel cell system and a fuel cartridge or battery.

2. The interconnect of claim 1 wherein the interface includes appropriate mating fittings to allow a fuel cartridge to connect to the interconnect.

3. The interconnect of claim 2 wherein the mating fittings provide an ingress fuel interface port.

4. The interconnect of claim 2 wherein the matting fittings are a valve or ingress port device to allow secure, leak-proof mating with a complementary port on a fuel cartridge.

5. The interconnect of claim 1 wherein the interface includes appropriate mating fittings to allow a battery to connect to the interconnect.

6. The interconnect of claim 1 wherein the interface includes a pair of spring-loaded battery terminal contacts placed in at least two coplanar locations.

7. The interconnect of claim 1 wherein the interface includes a pair of spring-loaded battery terminal contacts placed in at least two non-coplanar locations.

8. An electronic device comprises:
a operable unit that operates using a fuel cell; and
a housing including a compartment for receiving a fuel cartridge when the operable unit is operated by power generated by the fuel cell and for receiving a battery when the operable unit is operated by power from a battery, the housing including
an interface between a fuel cell system and a fuel cartridge or battery.

9. The device of claim 8 wherein the device is a portable electronic device.

10. The device of claim 8 wherein the housing has a door to enclose the compartment, the door being pivot-able and affixed to the housing.

11. The device of claim 8 wherein the housing has a door to enclose the compartment, the door being detachable from the housing.

12. The device of claim 8 wherein the interface includes appropriate mating fittings to allow a fuel cartridge to connect to the interconnect.

13. The device of claim 12 wherein the mating fittings provide an ingress fuel interface port.

14. The device of claim 12 wherein the matting fittings are a valve or ingress port device to allow secure, leak-proof mating with a complementary port on a fuel cartridge.

15. The device of claim 8 wherein the interface includes appropriate mating fittings to allow a battery to connect to the interconnect.

16. The device of claim 8 wherein the interface includes a pair of spring-loaded battery terminal contacts placed in at least two coplanar or non-coplanar locations.

17. The device of claim 8 wherein the interface includes a pair of spring-loaded battery terminal contacts placed in at least two non-coplanar locations.

18. An article comprises:
a generally rectangular solid shaped case having a pair of electrical terminals, housing at least one cylindrical battery having positive and negative electrodes coupled to the electrical terminals of the housing.

19. An article comprises:
a generally rectangular solid shaped case having a pair of electrical terminals and an aperture disposed between the pair of terminals to receive an ingress port.

20. The article of claim 19 wherein the case houses at least one cylindrical battery having positive and negative electrodes coupled to the electrical terminals of the housing.

21. The article of claim 19 wherein the case houses at least one prismatic battery having positive and negative electrodes coupled to the electrical terminals of the housing.

22. An interconnect comprises:
an interface between a fuel cell system and a fuel cartridge or battery; and
a circuit to prevent charging of a fuel cell from a battery when a battery is attached to the interconnect.

23. The interconnect of claim 22 wherein the circuit is a diode.

24. The interconnect of claim 22 wherein the circuit is a diode disposed in the interconnect and arranged to be coupled between a fuel cell and external battery terminals of the interconnect that can receive a battery, such that when the fuel cell is supplying the power, the diode is forward biased, and the external battery terminals are at open circuit, and when an external battery is connected to the contacts the diode is reverse biased and the battery supplies power to a load.

25. The interconnect of claim 22 wherein the circuit is a transistor-based switching circuit.

26. The interconnect of claim 22 wherein the circuit includes:
a first transistor biased through a resistor to conduct power from the fuel cell to a load; and
a second transistor arranged where if an external battery is inserted, the gate voltage of the first transistor turns the transistor off, preventing connection of the fuel cell to the battery, and the second transistor is biased through a second resistor to conduct power from the battery to the load.

27. The interconnect of claim 22 wherein the transistors are MOSFET's.

28. The interconnect of claim 22 wherein the transistors are p-channel MOSFET's.

29. An electronic device comprises:
electrical circuits that provide operative functionality of the device;
a fuel cell to power the electrical circuits during certain periods of operation;
an interconnect to connect between a battery and a fuel cartridge to delivery fuel to the fuel cell or power from the battery; and
a circuit to prevent charging of a fuel cell from a battery when a battery is attached to the interconnect.

30. The interconnect of claim 29 wherein the circuit is a diode.

31. The interconnect of claim 29 wherein the circuit is a diode disposed in the interconnect and arranged to be coupled between the fuel cell and external battery terminals of the interconnect that can receive a battery, such that when the fuel cell is supplying the power to the electrical circuits, the diode is forward biased, and the external battery terminals are at open circuit, and when an external battery is connected to the contacts the diode is reverse biased and the battery supplies power to the electrical circuits.

32. The interconnect of claim 29 wherein the circuit is a transistor-based switching circuit.

33. The interconnect of claim 29 wherein the circuit includes a first transistor biased through a resistor to conduct power from the fuel cell to the electrical circuits; and
a second transistor arranged where if an external battery is inserted, the gate voltage of the first transistor turns the transistor off, preventing connection of the fuel cell to the battery, and the second transistor is biased through a second resistor to conduct power from the battery to the electrical circuits.

34. The interconnect of claim 33 wherein the transistors are MOSFET's.

35. The interconnect of claim 33 wherein the transistors are p-channel MOSFET's.

36. The interconnect of claim 33 wherein the circuit is incorporated within the interconnect.

37. The interconnect of claim 33 wherein the circuit is incorporated within the electrical device.
